(19) United States
(12) Patent Application Publication
(10) Pub. No.: US 2012/0166279 A1
(43) Pub. Date: Jun. 28, 2012

(54) Mobile Marketing and Purchasing System

(76) Inventor: Nicholas Simon Collins, South Yarra (AU)

(21) Appl. No.: 13/331,693

(22) Filed: Dec. 20, 2011

(30) Foreign Application Priority Data
Dec. 22, 2010 (AU) 2010905572

(51) Int. Cl. G06Q 30/02

(52) U.S. Cl. 705/14.53

(57) ABSTRACT

An online system enables a customer to complete a purchase based only upon a product offer identifier, e.g., in a promotional campaign or in offers delivered by coupons. Each customer is associated with a customer device, which accesses the online system via a communications network. A database contains customer records, merchant records and product offer records with one or more merchant offers. A product offer identifier is sent from a customer device, and the online system retrieves corresponding merchant offers. A description of the product offer, along with details of the merchant offers is sent back to the customer device. A user of the device selects a merchant offer, and the selection is sent back to the online system. The system is configured to complete a transaction whereby hinds are transferred from a customer account to a selected merchant account, and the merchant is notified of the transaction.

### FIELD OF THE INVENTION

The present invention relates to electronic commerce systems, and is particularly directed to a method and system for offering products for sale in both online and offline environments, and facilitating online purchase by customers using a variety of different access means, including mobile devices.

### BACKGROUND OF THE INVENTION

Electronic commerce, i.e. the marketing and sale of goods and services via the internet and other data communications networks, has become increasingly widespread in recent years.

Internet-based electronic commerce is generally based on an ‘online shop’ model. A merchant having goods or services (collectively ‘products’) for sale establishes an online presence in the form of a website. Prospective customers may visit the website, identify products of interest, and purchase products via an online checkout process. This form of electronic commerce system has the advantage of being accessible via, any web-enabled device. However, it also suffers from a number of disadvantages.

Firstly, it is generally necessary for every online merchant to establish its own web-based electronic commerce shop. Customers generally need to register and/or provide relevant payment and delivery details to each individual merchant from which they purchase products online. These disadvantages, from both the merchant's and customer's point of view, are only partly alleviated by the use of existing marketing and payment platforms, such as eBay and PayPal.

Furthermore, many web-based electronic commerce sites are not readily usable by customers utilising handheld mobile devices. For example, the complex product search, selection and checkout processes employed on many web-based electronic commerce sites are unsuitable for use on small hand-held devices, such as mobile phone handsets.

An alternative mechanism available for making product purchase offers, and receiving orders, via hand-held mobile devices may be provided by the prospective customer's telecommunications service provider. For example, the service provider may facilitate the sending of an SMS or MMS message to prospective customers via its mobile network. The customers may be able to accept the offer, also via SMS, MMS or return phone call. Payment for the product is effected by adding the cost of the product to the customer's telephone bill. When the bill is paid, the service provider remits the relevant payment, typically minus a handling fee, to the merchant. This model is currently and particularly prevalent in respect of relevant electronic products, such as ringtones and wallpapers for use on mobile telephones.

However, this system also has a number of disadvantages. Firstly, the overall market available to a merchant is limited to customers of the particular service provider facilitating the offer. It is onerous for a merchant to establish the relevant business relationships for all service providers in a competitive telecommunications market. From the customer's point of view, the product range is limited to only those offerings from merchants having a direct relationship with their service provider. The payment may be limited by the type of account held by the customer with the service provider, with pre-paid accounts, for example, being treated differently from post-paid accounts. In addition, both the merchant and the customer are at the mercy of the charging regime imposed by the telecommunications service provider.

Additionally, there is currently a disconnect between the worlds of online and offline commerce. While offline advertising, for example in newspapers, magazines, brochures and catalogues, may include information, such as URLs, directing readers to online stores, they do not in any way simplify or facilitate the actual purchase of products or services in the online environment. In some markets, such as in North America, redeemable paper coupons or vouchers remain a popular means for manufacturers to promote their products, and for consumers to obtain special deals or discounts on items of interest. Conventionally, such coupons are clipped from booklets or brochures, and then taken to a physical retail outlet store from which the promoted product is purchased at a discounted price corresponding with the coupon.: The retailer then forwards the retained coupon to a clearing house, where it is further processed in accordance with the relevant promotional campaign. This may include, for example, a rebate of the discount provided back to the retailer, and/or other payments by the original product manufacturer to parties involved in operating the promotional campaign, such as publishers, distributors and/or the operators of the clearing house.

Clearly, there are a number of inefficiencies in the coupon system that might be alleviated through the use of technology, and in particular it would be desirable to make coupon-based offers available through one or more online retailers.

Accordingly, there is a need for an electronic commerce system and process that is able to facilitate the marketing and purchase of products via mobile devices that is independent of particular telecommunications service providers, but which remains suitable for use via small handheld devices, such as mobile telephones, and avoids the added complexity in product selection and purchasing typically associated with electronic commerce websites.

Additionally, there is a need for an electronic commerce system and process that is able to facilitate the marketing and purchase of products through online outlets, even where those products may be promoted through conventional offline mechanisms, such as the publication and distribution of clippable coupons.

It is an object of the present invention to provide such a system and process.

### SUMMARY OF THE INVENTION

In one aspect, the present invention provides a method of operating a server computer system to facilitate transactions between a plurality of merchants and a plurality of customers, wherein each customer is associated with at least one customer device in communication with the server computer system via a communications network, the method comprising the steps of:

providing at least one database configured to contain customer records, merchant records and product offer records, wherein
each customer record includes a unique customer identifier, and information identifying a customer payment account,
each merchant record includes information identifying a merchant deposit account, and
each product offer record includes a unique product offer identifier and a product description, and wherein
each product offer record is associated in the database with one or more corresponding merchant offers, each of which comprises a product price associated with a corresponding merchant record;

the server receiving from a customer device a customer identifier and a product offer identifier;

the server retrieving from the database a product offer record corresponding with the product offer identifier, and transmitting the product description stored in the product offer record to the customer device;

the server retrieving from the database one or more merchant offers associated with the retrieved product offer record and transmitting corresponding merchant details and the product price in each merchant offer to the customer device;

the server receiving from the customer device a selection of one of the retrieved merchant offers;

the server executing a transaction, including transferring funds to the merchant deposit account from the customer payment account corresponding with the customer identifier; and

the server transmitting a notification message to the merchant system, including details of the executed transaction.

Advantageously, embodiments of the invention enable customers to complete an online purchase without the need to proceed through the various steps generally involved when interacting with an e-commerce web site. The unique customer identifier may be a device identifier, such as a telephone number associated with a mobile device, enabling customer details, including account details, to be retrieved from the database without the need for additional interaction by the customer.

The customer may simply enter a product offer identifier, such as a numeric or alphanumeric code, and will receive back in reply the relevant details of one or more merchants which are able to supply the selected product, along with corresponding prices, including a discount provided by the associated product offer. From the customer's perspective, selection of a single preferred merchant enables a transaction to be completed via the server system, and notification provided to the merchant, such that the selected product will be purchased and delivered with substantially reduced effort on the part of the customer.

The system may be used for online promotions, in which messages containing product offers, with associated product offer identifiers, may be sent electronically to the customer device, for example via email, SMS message, MMS message, or other messaging protocol. Advantageously, the system may also be used to facilitate the implementation of offline promotional campaigns, in which the product offers are advertised via conventional means, such as in print advertisements, clippable coupon books, and the like. A product offer identifier, in the form of a short numeric or alphanumeric code, a barcode, or a two-dimensional QR code, may be included in the printed promotion. Machine-readable codes, such as barcodes or QR codes, may be scanned directly using a customer mobile device, such as a smart phone, or similar, equipped with a camera. As is known, application software executing on a smart phone, or similar device, is able to decode such information, and pass the decoded identifiers to other applications, such as a web browser, or a dedicated . e-commerce application, for use in transmitting a customer request to purchase the offer product.

In some embodiments, a dedicated application (or ‘app’) is developed and provided for execution on portable devices, such as those running Apple's iOS, or Google's Android operating systems, to facilitate customer interaction with the server computer system. Alternatively, product offer identifiers may be transmitted to the server computer system via SMS, or a simple web interface. For example, in a web-based implementation, suitable for use via a range of customer devices supporting browser software, the customer may be required only to log in and enter a product offer identifier in order to be guided simply through the remainder of the offer and purchase process.

As a further advantage, embodiments of the invention are able to provide a single access point to facilitate sending product offers to prospective customers via their mobile devices, and accepting and completing corresponding purchase transactions. Both merchants and prospective customers may register with a single service provider, and their details are stored in the database. Customer records contain all of the information necessary to deliver product offers to customers, and in particular the unique customer device identification number may be a telephone number enabling offers to be sent via SMS or MMS messaging. For customers with smart phones or similar mobile devices, product offers may alternatively be delivered via specialised applications.

Customer payment account identifiers may include details, or references to details, such as credit or debit card numbers which enable payments to be made without the need for the customer to provide these details with every transaction, or to register with individual merchants. Merchant records include merchant deposit account details, to enable transactions to be completed, so that the delivery of products may be authorised.

In preferred embodiments, the database further includes customer delivery details, and the method includes sending a message including the delivery details corresponding with the customer device from which the validated message was received to the merchant system and/or a nominated logistics provider system.

Advantageously, the end customer does not need to provide delivery details for products purchased because the necessary details are already held with the database. For physical goods, the delivery details may include a delivery address, and may further include additional details, such as a preferred method of delivery. For products including services and/or intangible goods (such as digital downloads), the delivery details may include an email address, and/or the customer's unique device identification number (e.g. phone number) for direct delivery to the hand-held device.

For online promotions, information relating to a product offer may include characterising information of target customers, and the method may include a step of identifying customers to whom the product offer may be sent. This may include identifying customer records in the database having contents corresponding with the characterising information.

For example, customer records may include additional personal details, such as age, gender, location, and a personal profile including interests. Additionally, records may be maintained of previous purchasing preferences of each customer. It is then possible for a merchant to specify the target market for a particular product offer according to any, or all, of these available characteristics.

Records of requests for product offer information, selected merchant offers, and transactions, may also be stored within the database. Subsequently, customers, merchants, suppliers, and/or publishers of promotional materials, may be enabled to access detailed records in relation to purchases or promotional campaigns. For example, analysis of stored information may enable data to be presented on the number of product offers viewed following the launch of a promotional campaign, the corresponding proportion of customers who went on to view associated merchant offers, and the subsequent proportion of actual sales, along with the merchants selected to provide the products in such cases.

In embodiments in which additional customer information is contained within the database, such as, for example, age, gender, professional background, education, and so forth, it may additionally be possible to provide further analytics based upon demographic breakdown of responding customers. Such additional information may be of great value to suppliers, merchants, and publishers and distributors of promotional information.

In another aspect the invention provides a server computer system comprising:

at least one processor;

persistent storage accessible to the processor comprising at least one database configured to contain customer records, merchant records and product offer records, wherein
each customer record includes a unique customer identifier, and information identifying a customer payment account,
each merchant record includes information identifying a merchant deposit account, and
each product offer record includes a unique product offer identifier and a product description, and wherein
each product offer record is associated in the database with one or more corresponding merchant offers, each of which comprises a product price associated with a corresponding merchant record;

at least one network interface operatively associated with the processor and configured to communicate with a plurality of customer devices; and

a memory operatively associated with the processor,

wherein the memory comprises data and executable program instructions configured to cause the processor to execute a method comprising steps of:
receiving from a customer device a customer identifier and a product offer identifier;
retrieving from the database a product offer record corresponding with the product offer identifier, and transmitting the product description stored in the product offer record to the customer device;
retrieving from the database one or more merchant offers associated with the retrieved product offer records, and transmitting corresponding merchant details and the product price in each merchant offer to the customer device;
receiving from the customer device a selection of one of the retrieved merchant offers;
executing a transaction, including transferring funds to the merchant deposit account from the customer payment account identified in the customer record associated with the customer identifier; and
transmitting a notification message, to the merchant system, including details of the executed transaction.

In yet another aspect the invention provides a method of operating a customer device in communication with a server computer system which is configured to facilitate transactions between a plurality of merchants and a plurality of customers, wherein the server computer system is associated with at least one database configured to contain customer records, merchant records and product offer records, wherein
each customer record includes a unique customer identifier, and information identifying a customer payment account,
each merchant record includes information identifying a merchant deposit account, and
each product offer record includes a unique product offer identifier and a product description, and wherein
each product offer record is associated in the database with one or more corresponding merchant offers, each of which comprises a product price associated with a corresponding merchant record;

wherein the customer device operation method comprises:

the customer device receiving an input including a product offer identifier;

the customer device transmitting to the server computer system a customer identifier associated with a user of the customer device, and the product offer identifier;

the customer device receiving from the server computer system a product description, and displaying the product description on a device display;

the customer device receiving from the server computer system details of one or more merchants associated with the product offer, and corresponding product prices, and displaying merchant details and prices on the device, display;

the customer device receiving a selection of one of the displayed merchant offers, and transmitting the selection to the server computer system,

whereby the server computer system is able to execute a transaction, including transferring funds to the merchant deposit account from the customer payment account associated with the customer identifier and to transmit a notification message to a corresponding merchant system including details of the executed transaction.

In a further aspect the invention provides a computer program product comprising a tangible computer-readable medium having stored thereon computer-executable instructions which, when executed on a customer device, cause the customer device to implement a method of operating a customer device, as set out above.

In some embodiments, the tangible computer-readable medium is operatively associated with a network-connected server, and the computer-executable instructions comprise one or more files available for download via the network, and for installation to the customer device. For example, the computer-executable instructions may be incorporated within a downloadable app configured for execution upon a portable customer device, such as a smart phone or tablet computer, whereby a suitable app installer may be made downloadable from a dedicated web site, or from an app market web site.

Further features and advantages of the present invention will be apparent from the following description of preferred embodiments, which are provided by way of example only, and are not limiting of the scope of the invention as defined in any of the preceding statements, or in the claims appended hereto.

### BRIEF DESCRIPTION OF THE DRAWINGS

Preferred embodiments will now be described with reference to the accompanying drawings, in which like reference numerals refer to like features, and wherein;

FIG. 1 is a block diagram illustrating a system embodying the invention;

FIG. 2 is a block diagram illustrating an exemplary server computer arrangement according to one embodiment of the invention;

FIG. 3 is a schematic diagram showing exemplary software functional components according to a first embodiment of the invention;

FIG. 4 is a flowchart illustrating an exemplary method for marketing, sale and delivery of a product, according to the first embodiment of the invention;

FIG. 5 is a flowchart illustrating an exemplary method for offline promotion, and online sale of a product, according to a second embodiment of the invention;

FIG. 6 is a diagram illustrating schematically exemplary database records according to the second embodiment of the invention;

FIG. 7 is a block diagram illustrating an exemplary mobile messaging architecture according to the second embodiment of the invention;

FIG. 8 is a block diagram illustrating an exemplary Internet-based architecture according to the second embodiment of the invention;

FIG. 9 illustrates an exemplary smart phone-based user interface for selection and purchase of products according to the second embodiment of the invention; and

FIGS. 10 to 13 illustrate exemplary web-based administration information screens according to the second embodiment of the invention.

### DETAILED DESCRIPTION OF PREFERRED EMBODIMENT

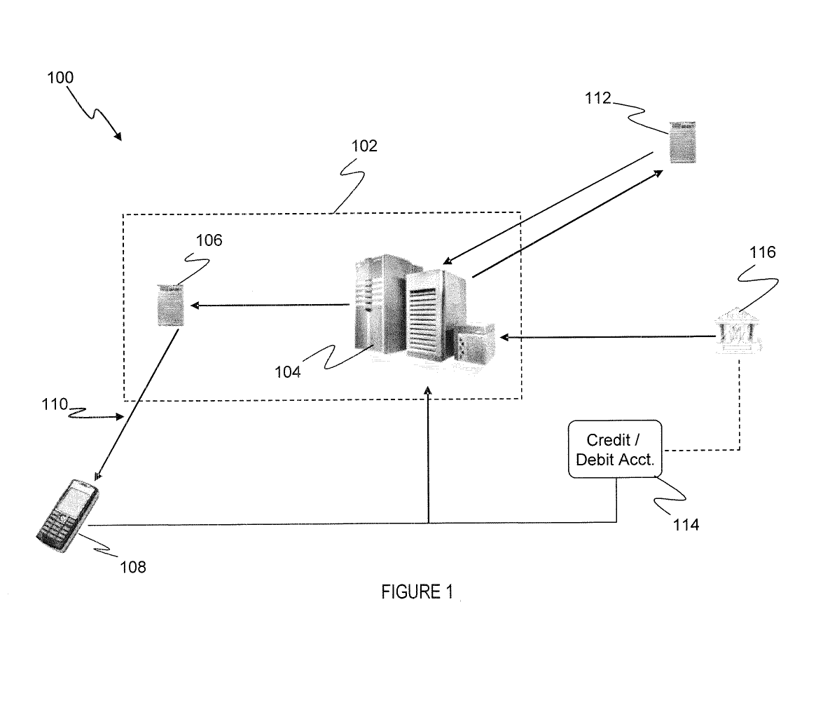

FIG. 1 is a block diagram 100 illustrating a system 102 for facilitating transactions between merchants and customers, in accordance with an embodiment of the invention.

The system 102 includes a management platform 104 and a messaging platform 106. In a typical implementation, the management platform 104 may comprise a server cluster, while the messaging platform 106 may comprise one or more additional server computers. Alternatively, the platforms 104, 106 may be implemented on a single local or distributed server system. In general, however, the system 102 may be implemented in a variety of different hardware environments, employing one or more server computers, each of which may comprise one or more microprocessors. In an embodiment, for example, the system 102 may be implemented principally via a ‘cloud computing’ platform, which advantageously enables a high level of scalability, while enabling the operator to avoid purchasing the significant dedicated resources necessary to handle peak loads. As such, the specific embodiments described herein, are exemplary only, and not limiting of the scope of the invention. In some embodiments the messaging platform 106 and the management platform 104 may be wholly operated by a single service provider, as in the arrangement 100. However, in alternative embodiments, the messaging platform 106 may communicate with a third party provider, different from the operators of the system 102. In particular, for SMS and MMS messaging, a number of existing providers offer messaging services accessible, for example, via a web based API.

As shown in FIG. 1, prospective customers are able to access the system 102 using mobile devices 108, such as GSM cellular mobile telephones, or smart phones. Messages may be sent from the messaging platform 106 to customer devices 108 via the mobile telephony network, and in particular through any mobile service provider to which the customer happens to subscribe. Messages may be conveniently delivered to a wide range of devices 108 via SMS or MMS, however it is also possible to deliver messages from the messaging platform 106 via IP-based services over GPRS, WAP and 3G networks. These latter technologies are most clearly applicable in the case of smartphone handsets, and similar devices, which may be provided with specialised applications for receiving and displaying message content. IP-based access may also be via other Internet-connected devices, such as desktop or laptop computers.

Merchant systems 112 are also able to access the management platform 104, for example via the internet.

The management platform 104 is also able to access electronic transaction services, including customer-nominated accounts 114, using the services of one or more financial institutions 116.

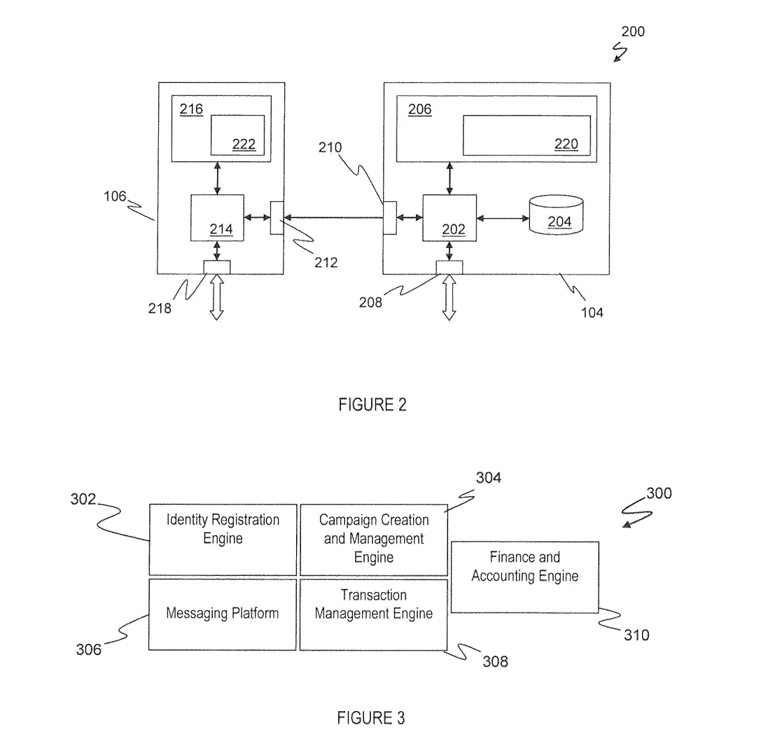

Further details of the implementation and operation of various embodiments of the system 102 will now be described with reference to FIGS. 2 to 13 of the accompanying drawings.

FIG. 2 is a block diagram 200 showing further details of the management platform 104 and messaging platform 106, in an embodiment configured to communicate via mobile messaging services, e.g. SMS or MMS.

The management platform 104 comprises one or more server computers, each of which includes at least one microprocessor 202. For simplicity, in much of the following description, it is assumed that the exemplary management platform 104 includes a single computer with a single microprocessor 202. However, as indicated above, in a large-scale implementation it is envisaged that the system 102 will be implemented via a cloud computing platform, or other server farm.

The microprocessor 202 is interfaced to, or otherwise operably associated with, a non-volatile memory/storage device 204. The non-volatile storage 204 may be a hard-disk drive, and/or may include a solid state non-volatile memory, such as read-only memory (ROM), flash memory, or the like. The microprocessor 202 is also interfaced to volatile storage 206, such as random access memory (RAM), which contains program instructions and transient data relating to the operation of the platform 104. In a conventional configuration, the storage device 204 maintains known program and data content relevant to the normal operation of the computer system. For example, the storage device 204 may contain operating system programs and data, as well as other executable application software necessary to the intended functions of the management platform 104. In the embodiment shown, the storage device 204 also contains program instructions which, when executed by the processor 202, enable the server computer to perform operations relating to the provision of a mobile marketing and purchasing system embodying the invention.

The microprocessor 202 is also operably associated with a network interface 208 in a conventional manner. The network interface 208 facilitates access to one or more data communications networks, such as the Internet, which may be used, for example, to communicate with merchant system 112 and financial institutions 116.

A further communications interface 210 enables the management platform 104 to communicate with the messaging platform 106. While a separate interface 210 is shown in FIG. 2, in alternative embodiments the management platform 104 may communicate with the messaging platform 106 via the internet, for example by using the same network interface 208 as is employed for other internet communications. In still further embodiments, the management platform 104 and the messaging platform 106 may be implemented within a single server, communicating via internal system services, such as inter-process communications.

In the embodiment shown in FIG. 2, the messaging platform 106 is a separate server computer receiving requests from the management platform 104 via a communications interface 212, which is operably associated with a microprocessor 214. The messaging platform 106 includes its own volatile storage 216, containing program instructions and transient data relating to the operation of the messaging platform 106. The messaging platform 106 may also include its own non-volatile storage (not shown), if required for long term storage of programs and data. A further communications interface 218 is operably associated with the microprocessor 214, which provides access to public telecommunications networks for the delivery of messages to mobile customer devices, e.g. 108.

In use, the volatile storage 206, 216 of the management and messaging platforms 104, 106 include corresponding bodies of program instructions 220, 222, configured to perform processing and operations embodying features of the present invention, for example in the embodiments described below with reference to FIGS. 3 to 13.

FIG. 3 is a schematic diagram 300 showing exemplary software functional components of a first embodiment of the invention. In particular, the software implementation includes an identity registration engine 302, a campaign creation and management engine 304, the messaging platform 306, a transaction management engine 308, and a finance and accounting engine 310.

The primary function of the identity registration engine 302 is to manage and maintain a database of customer and merchant records. The database may be stored, for example, within the non-volatile storage 204 of the management platform 104, and/or may be stored remotely and accessed via a data communications network. In a typical implementation, the database is accessed for update and/or retrieval using an industry standard query language, such as SQL.

A first function of the identity registration engine 302 is to receive and process registration requests from merchants and customers. The registration process for customers may involve accessing the management platform 104 via the internet, via a designated customer care centre (e.g. by telephone), or by application in writing. Whichever mechanism is used, customers provide relevant personal identification details for entry into the database. Basic operation of the system 300 requires a customer to provide a unique device identification number (typically a mobile phone number), for delivery of messages and verification of responses, as well as sufficient relevant account details to enable the completion of purchase transactions. The required account details may include, for example, credit card details (e.g. name, account number, and expiry date), and/or a debit account number and direct debit authority. Customers will also typically be required to provide a full name, a mailing or billing address, and a private security code for use in validating purchase requests. It is also desirable for customers to provide a nominated delivery address (for delivery of physical items), and personal details, such as date of birth, gender, personal preferences, and so forth, which may be used for a variety of purposes, including identifying the customer's likely level of interest in particular product offers, and demographic profiling of customer transactions.

The registration process for merchants, vendors or suppliers of products may involve accessing the management platform 104 via the internet, designated customer care centre (e.g. via telephone), or via a specific application. Typically, merchants will be required to provide contact details (e.g. name, address, an associated device identification number, authentication questions and so forth). Importantly, merchants provide deposit account details, such as account number, acceptable payment details, and any other details required to enable the management platform 104 to complete financial transactions between a customer and the merchant. Further details that may be provided by a merchant and stored within the database include delivery process creation details (i.e. information necessary for the management platform 104 to initiate product delivery upon completion of a transaction) and the merchant's terms and conditions of trade.

The registration of customers and merchants provides sufficient information, all of which is stored in the database, for the management platform 104 to create the appropriate linkages between customer and merchant, and their respective financial institutions, when required. Preferably, all data stored in the database maintained by the identity registration engine 302 is encrypted using a strong cipher, such as the triple DES standard for data security and protection. Access to this information is restricted by the identity registration engine 302 to trusted entities, including the campaign creation and management engine 304, the transaction management engine 308, and the finance and accounting engine 310.

The campaign creation and management engine 304 performs a number of functions relating to the processing of merchant product offer information, delivery of product offer messages to selected customers, and validation of responses to the product offer. Specifically, a merchant may access the management platform 104 via a merchant's computer system 112, in order to create a product offering to registered customers. The campaign creation and management engine 304 is configured to receive product offering information, including at least a product description and a product price. The merchant may provide additional details, such as the characteristics of the desired target market. For example, intended targets may be identified by characteristics such as age, gender, geographic location, personal interests, and/or previous purchasing preferences, all of which may correspond with information held within the database managed by the identity registration engine 302.

Additional content may also be provided by the merchant, such as still images or animated graphics, which may be included in product offer messages delivered, for example, via MMS.

The campaign creation and management engine 304 accesses the database maintained by the identity registration engine 302, in order to identify those registered customers that satisfy the target market criteria specified by the merchant. If no limiting criteria are provided, then all registered customers may be identified.

Once a list of target customers has been identified, the campaign creation and management engine 304 formats appropriate messages, and communicates them to the messaging platform 306, along with the corresponding customer device details, i.e. the unique device identification numbers. The messaging platform processes this information, and delivers the messages to the customer devices. The messages are typically formatted to enable the customer to respond, e.g. to accept the merchant offer, in a simple and convenient manner. For example, depending upon the capabilities of a particular customer device, the message may enable the customer to accept the offer and initiate a transaction by replying via SMS to a specified number, by clicking on a graphical user interface element (e.g. a button), or by accessing a hyperlink delivered with the message. Any such acceptance responses are delivered back to the messaging platform 306, which passes the response details back to the campaign creation and management engine 304. Preferably, the details returned to the campaign creation and management engine 304 include the unique identifying number of the sending customer device (e.g. the mobile telephone number available using Calling Line Identification, CLI), along with a personal security code that has been entered by the customer. For example, the customer's personal security code may be returned in the body of an SMS message reply.

The campaign creation and management engine 304 passes the returned details on to the identity registration engine 302 which compares the returned details with the corresponding customer record in the database. Assuming that the device identification number and the personal security code match the customer record, details are routed to the transaction management engine 308 for authorisation.

The transaction management engine 308 is configured to verify and execute transactions between the payment account of a customer who has provided a valid response to the product offer (as determined by the identity registration engine 302), and the corresponding merchant deposit account. The transaction management engine 308 first obtains a purchase authorisation from the customer's financial institution. The purchase authorisation confirms that the customer has sufficient funds (i.e. remaining credit on a credit card, or remaining balance in a debit account) to complete the transaction. If the authorisation completes successfully, then the transaction management engine 308 proceeds with the transaction, otherwise the transaction is declined.

If the transaction is authorised, the transaction management engine 108 generates a payment receipt message, and passes this to the messaging platform 306, which forwards a corresponding message (e.g. an SMS or MMS message) comprising the payment receipt and any other relevant information, such as delivery details, to the customer device 108. Details of the transaction are then passed by the transaction management engine 308 to the finance and accounting engine 310, which updates the customer account record, the merchant account record, and completes the requisite transactions via the financial institutions 116 to settle the transaction to the merchant's transaction account. The finance and accounting engine 310 may also notify the campaign creation and management engine 304, so that it may update its own records associated with the merchant offer, and the customer record maintained by the identity registration engine 302 may also be updated with details of the transaction, for future reference.

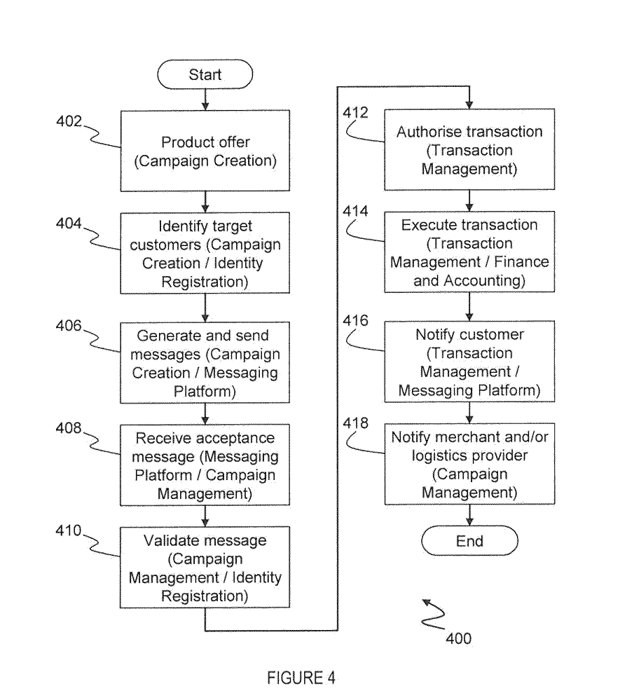

The overall process carried out by the system 102 in this first embodiment is summarised in the flowchart 400 illustrated in FIG. 4. At step 402, product offer details are received by the management platform 104 from the merchant system 112. The product offer details are processed by the campaign creation and management engine 304. The campaign creation and management engine 304 accesses the identify registration engine 302 in order to identify target customers at step 404. At step 406, the campaign creation and management engine 304 generates offer messages and transfers the relevant messages and customer details to the messaging platform 306.

At step 408, the messaging platform 306 receives offer acceptance messages in reply from customer devices 108. At step 410, the acceptance messages are validated, by comparing the unique identifying number (e.g. telephone number) of a customer device 108 and a supplied customer personal security code, with details held in the corresponding customer record maintained by the identity registration engine 302. If the validation is successful, then the transaction is authorised by the transaction management engine 308 at step 412. If the authorisation is successful, then the transaction is executed at step 414, by the transaction management engine 308 passing the relevant transaction details to the finance and accounting engine 310. The customer is notified of the successful transaction, and provided with a receipt delivered to the customer device 108, at step 416.

The exemplary system 102 is also able to initiate delivery of the products ordered by the customer. This function is indicated by step 418, in which the merchant and/or an associated logistics provider is notified of the successful completion of the transaction. This notification is preferably generated electronically, and in the case of a physical product may initiate the completion, packaging and shipping of the customer order. Delivery details may be supplied to the merchant or logistics provider from the customer information held in the database maintained by the identity registration engine 302. For intangible goods, including digital products, delivery may be effected directly to the customer device 108, or may involve sending a message, such as an SMS or an email, to the customer which includes details for downloading the purchased digital product via the internet.

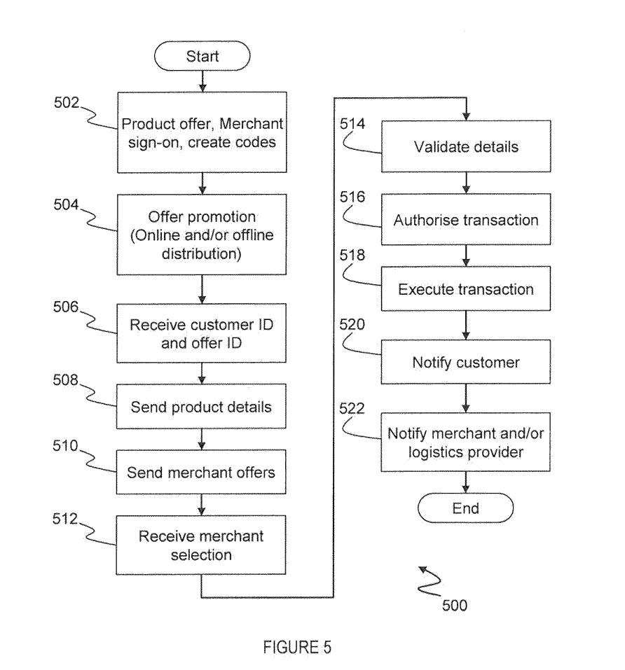

A process carried out by a system in a second embodiment of the invention is summarised in the flowchart 500 illustrated in FIG. 5. In this embodiment of the invention, the system is particularly configured for use in combination with offline promotions, such as product offers published in print advertisements, newspapers, magazines, brochures or catalogues, and in particular may be used with clippable paper coupons or vouchers. The process 500 represents the running of a particular ‘campaign’, which may be, for example, the promotion of a selected set of products by a product manufacturer or supplier over a fixed period of time, such as by the publication of corresponding coupons or vouchers in a weekly coupon book.

At step 502, one or more products are selected to be the subject of offers in the course of the campaign. For each product that is offered, one or more merchants, e.g. online retailers or distributors, sign on to participate, by offering the selected product for sale at a discounted price. Additionally, one or more product identifiers, or codes, are created, any one of which uniquely identifies the product offer, distinguishing it from other offers in the campaign, or in any other campaign. The unique product identifiers may be encoded as one or more of a text-based (e.g. alphanumeric) code, a barcode, a QR code, and so forth.

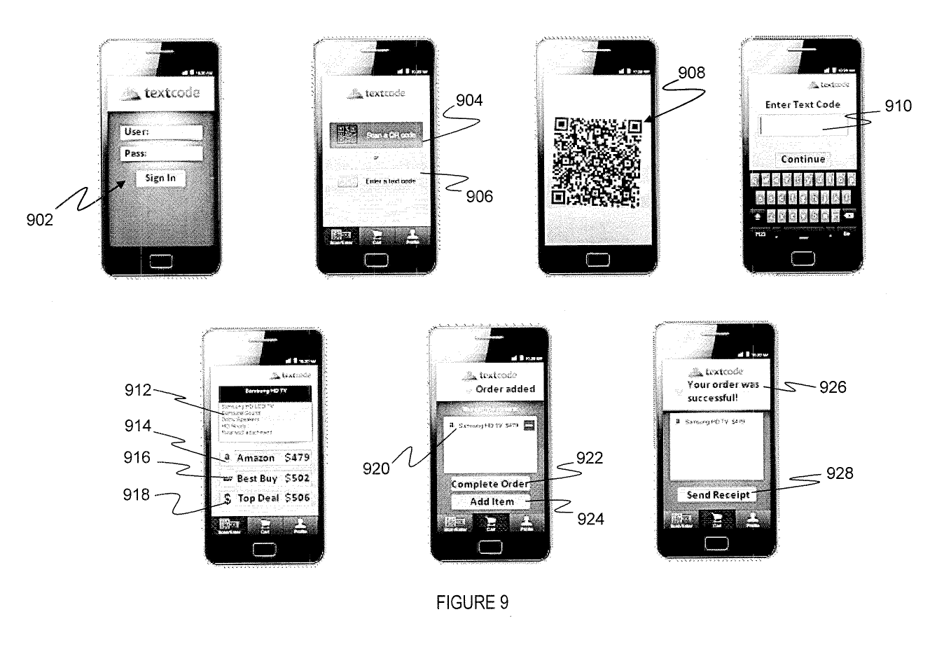

At step 504, the product offers are promoted via offline and/or online distribution channels. In particular, in the case of offline distribution, printed materials, such as advertisements, vouchers or coupons, include copies of the offer identifier codes created at step 502. Advantageously, the promotional materials may include both of a text-based code, and a machine-readable code, such as barcode or QR code. This enables a customer either to enter the text-based code manually, or to electronically decode the machine-readable code using a suitable device. For example, two-dimensional QR codes have become popular due to the wide availability of decoding software installable on devices such as smart phones, which have built-in cameras for capturing images of the codes. Further details of exemplary customer entry of codes are provided below, with reference to FIG. 9.

Once a customer has entered a code corresponding with a product offer, it can be transmitted back to the server computer system, where the unique offer identifier and a unique customer identifier, are received at step 506. The server system retrieves details of the product offer from its database, and sends the details back to the transmitting customer device at step 508. Additionally, at step 510, the server system sends the corresponding one or more merchant offers, including the merchant name and/or other identifying information, and the discounted price at which the merchant is selling the product during the campaign. The customer device facilitates the customer selecting one of the merchant offers, which is sent back to the server system, and received at step 512. Typically, the customer's selection will require validation at step 514, and a corresponding transaction will require authorisation, at step 516. These steps may include a final confirmation that the customer wishes to proceed with the transaction, as well as confirming the availability of funds in the customer's nominated account.

The transaction is executed at step 518, and the customer notified at step 520. At step 522, the merchant and/or an associated logistics provider is notified of the successful completion of the transaction.

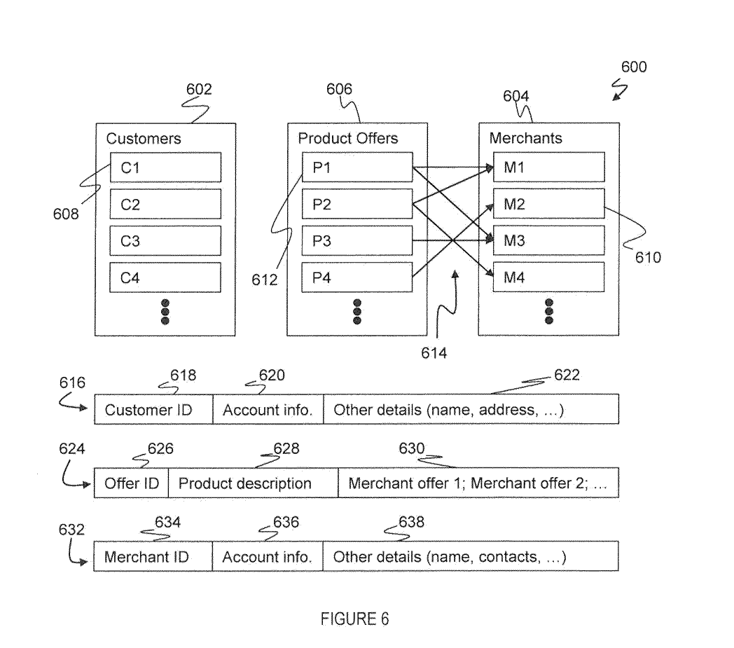

FIG. 6 is a schematic diagram 600 illustrating exemplary database records comprising the information required to implement the process 500. The database includes customer records 602, and merchant records 604, which may contain information as captured by the identity registration engine 302 described above in relation to the first embodiment. Additionally, the database includes product offer records 606. The customer records 602 comprise a plurality of individual customer entries, e.g. 608. Similarly, the merchant records 604 comprise one or more individual merchant entries, e.g. 610. The product offer records 606 comprise a plurality of individual product offer entries, e.g. 612, which may be created at step 502 of the process 500.

As indicated by the arrows 614, each product offer entry 612 is associated with one or more merchant entries 610. This association is also created at step 502 of the process 500, when a merchant signs on to participate in the product offer. However, this is not the only possible method for association of merchants with product offers. For example, once a product offer entry 612 has been created, merchants may be able to access the online system and subsequently sign up to provide a competing discounted price in relation to one or more offers in an existing campaign.

In further detail, a customer record entry 616 may include a unique customer identifier 618, customer account information 620, and additional customer details 622, such as name, billing address, delivery address, interests, and so forth. The unique customer identifier may be a device identifier, such as a mobile telephone number, or may be another identifier, such as a user name, email address, or the like.

In further detail, a product offer record entry 624 includes a unique offer identifier 626, a product description 628, and details of one or more associated merchant offers 630. The merchant offers may include references to the participating merchants, along with the discounted offer price being offered by each merchant. The product offer record entry 624 may include further information, such as a photograph or other image depicting the product, or some other aspect of the offer.

In further detail, a merchant record entry 632 includes a unique merchant identifier 634, merchant payment account information 636, and further details of the merchant 638, such as merchant name or other identifying information, merchant contact details, and so forth.

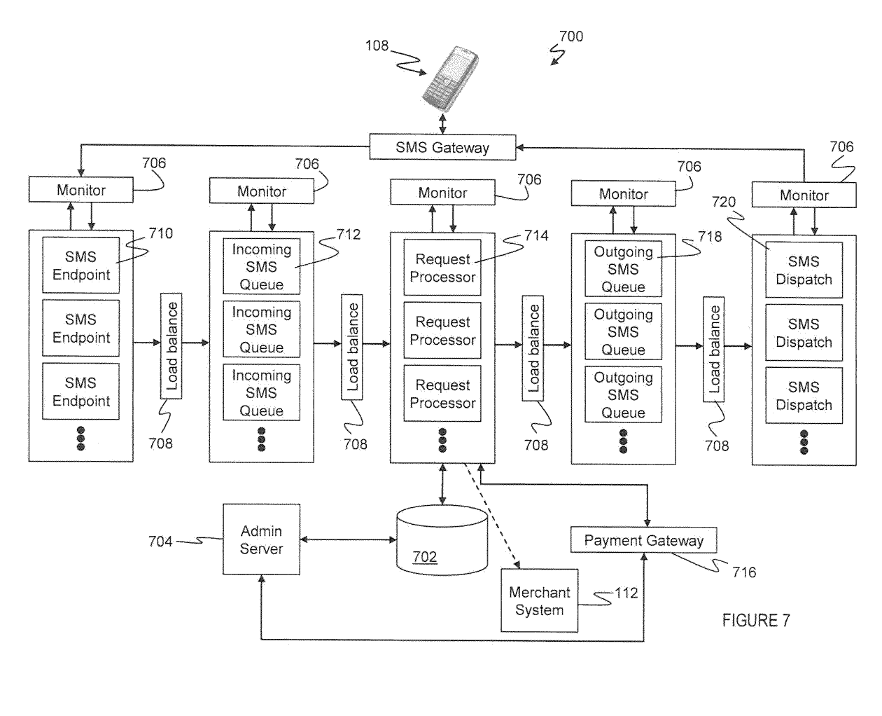

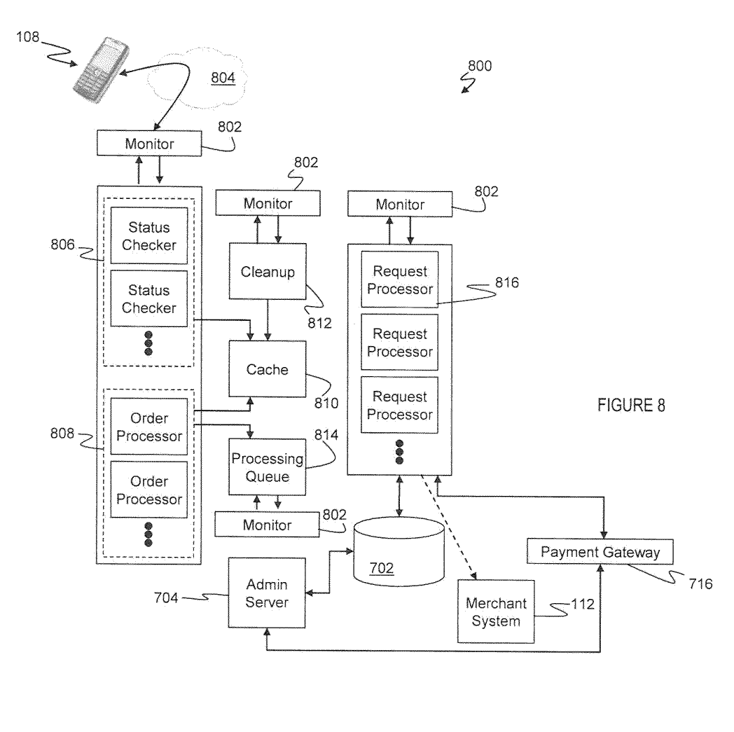

FIG. 7 is a block diagram illustrating an exemplary Mobile messaging architecture 700 according to the second embodiment of the invention. The system architecture 700 may be implemented using a single-server computer, a multiple-server farm, or a cloud computing platform, for maximum flexibility. In order to facilitate implementation on a cloud computing platform, the architecture 700 is designed to be highly scalable, such that computing resources may be allocated and released on demand. The system shown in FIG. 7 is configured, in particular, for operation using a cellular mobile messaging system, whereby a wide range of customer devices 108 are able to interact with the system via an SMS gateway 106.

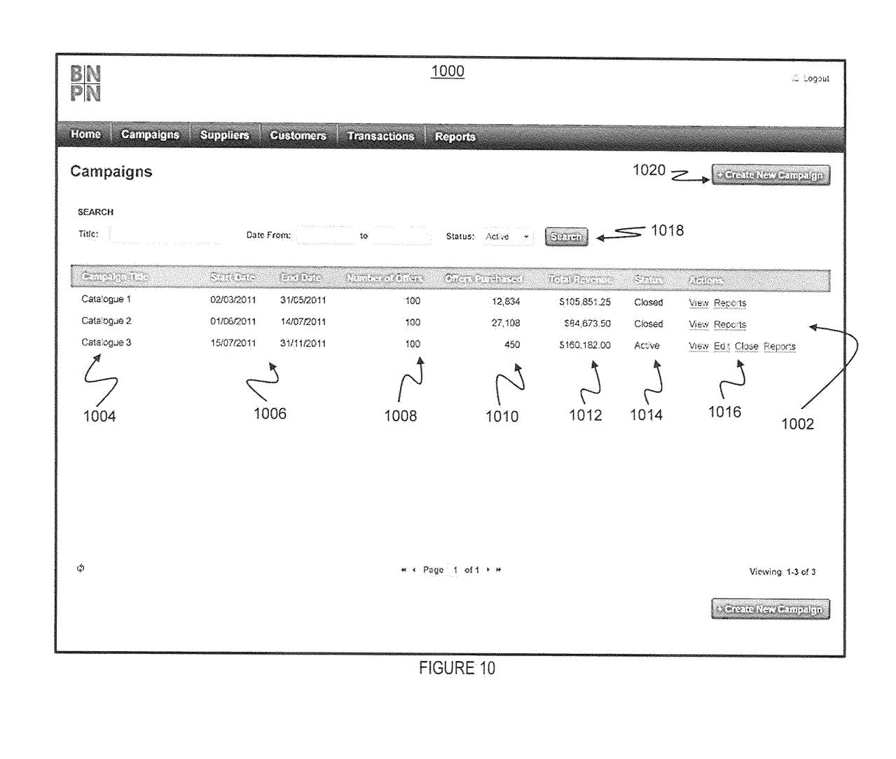

A database 702 contains customer records, product offer records, and merchant records, as illustrated in FIG. 6. An administration server 704 is provided to enable access to, and maintenance of, the database 702. In particular, the administration server 704 may be used for campaign creation, i.e. the implementation of step 502 of the process 500. Additionally, the administration server 704 may provide suppliers and merchants with access to additional information regarding the progress and performance of promotional campaigns, and individual product offers. Further discussion of the functions that may be provided by the administration server 704 is provided below, with reference to FIGS. 10 to 13.

The software architecture 700 includes a number of monitoring processes 706. Each monitoring process 706 is associated with a corresponding module in the overall architecture. The modules are scalable, in that they are configured to enable additional processes to be instantiated in response to demand, under control of the associated monitoring process 706. Added processes may execute one or more central processing units within a server farm, and required hardware resources may be allocated upon demand within a cloud computing platform.

When demand falls, the monitoring processes 706 may release unneeded resources.

In the software architecture 700 a number of load-balancing processes 708 are provided to regulate the allocation of incoming requests to available processing resources. Processing takes place in a number of stages, represented by the modules 710, 712, 714, 718 and 720.

Module 710 implements SMS endpoints, which receive incoming SMS message contents transmitted from customer devices 108. Each incoming SMS message includes a unique offer identifier, such as a text code that has been entered into an SMS message body by the user of a customer device 108. Each message is also associated with a unique customer identifier, which may be the mobile telephone number of the device 108. Received messages are passed via a load-balancing module to an incoming SMS message queue in the module 712. Messages are de-queued in turn, and passed via a further load-balancing module to an SMS request processor within the module 714. The SMS request processor 714 accesses the database 702 in order to identify the product offer corresponding with the received offer identifier code, associated merchant offers, and relevant customer account details. The SMS request processors 714 generate return messages, which may include product description messages, messages containing available merchant and price details, and/or transaction related messages. When an incoming customer message includes instructions to complete a transaction, the SMS request processing module 714 accesses the payment gateway 716 in order to obtain authorisation, and to complete a transaction whereby funds are transferred from an identified customer account to a relevant merchant payment account.

Outgoing messages generated by the SMS request processor module 714 are passed via another load-balancing module to an appropriate outgoing SMS queue, maintained by the outgoing queue module 718. Messages are de-queued in turn, and passed via a further load-balancing module 708 to the SMS dispatch module 720. Processes within the SMS dispatch module transmit SMS message content to the SMS gateway 106, from which it is transmitted via the cellular mobile network to the customer device 108.

Overall, therefore, the SMS gateway, SMS endpoint module 710, and incoming SMS queue module 712, provide for upstream messaging between the customer device 108 and the request processing module 714. Furthermore, the outgoing SMS queue module 718, the SMS dispatch module 720, and the SMS gateway 106 provide for downstream messaging from the request processor module 714 to the customer device 108. A purchase may be completed after one or more messaging transmissions between the customer device 108 and the request processing module 714. Upon completion and confirmation of a purchase, the merchant 112 is notified of the sale, and provided with relevant customer details in order to complete delivery of the purchased product to the customer.

FIG. 8 is a block diagram illustrating an exemplary Internet-based architecture 800 also generally according to the second embodiment of the invention, i.e. implementing the process 500. It will be noted that the architecture 800 has a number of elements in common with the architecture 700, including the database 702, the administration server 704, the payment gateway 716, and communication with the merchant 112. In general, the modules of the mobile messaging architecture 700 and the Internet-based architecture 800 may be integrated into a single system, providing service via both messaging channels.

The architecture 800 also employs a scalable modular approach, including monitoring processes 802 which are responsible for allocating and releasing resources in accordance with demand.

Customer devices 108 access the server system via the Internet 804. Access may be via any combination of wired and/or wireless connections, and the customer device 108 may be a smart phone or other portable device, or may be any Internet-connected device, portable or otherwise, executing suitable software, such as a conventional web browser. In some embodiments, dedicated apps may be developed and installed on portable devices 108 to facilitate convenient access to the system, and one such example is described below with reference to FIG. 9.

Communications with the customer device 108 are managed by a front-end system, which includes status checking modules 806 and order processing modules 808. Status checking modules 806 are responsible for customer and device identification and verification, while order processing modules 808 are responsible for offer related communications with verified devices. A cache memory 801 is maintained, for storing state information associated with ongoing sessions with customer devices 108. A cache management module 812 is responsible for monitoring and releasing unused resources within the cache 810. As requests come in via the order processing modules 808, they are queued for further processing within the processing queue module 814. Requests are successively de-queued, and are processed by the request processing modules 816. These modules access the database 702 in order to obtain relevant campaign, offer and merchant details, in order to complete the various relevant stages of the process 500. As in the mobile messaging architecture 700, transactions are processed via the payment gateway, and notifications of completed transactions forwarded to the relevant merchant 112.

FIG. 9 comprises a series of illustrations showing an exemplary smart phone-based user interface, implemented via an installed app, for selection and purchase of products via the system architecture 800. As is well-known, smart phone apps may be developed for popular smart phone operating systems, such as Apple's iOS, or Google's Android, and made available as installation files that are downloadable from appropriate web-based servers. For example, apps for Apple devices are generally available for download from Apple's App Store, while apps for Android-based devices are available for download via the Android Market, and may also be made available from other servers.

Upon execution of the installed app, the user may be presented with a screen 902 for entry of a user identifier and password, in order to sign in to the system. The app is configured to transmit this information securely to the server system, where it is processed by the status check modules 806. Following successful sign-in the app may present a second screen, providing the user with an option to scan and process a machine-readable code, such as a QR code (touch screen button 904), or alternatively to manually enter a text code (touch screen button 906).

If the user has obtained a printed promotional offer including a machine-readable code, such as a QR code, the user will be prompted to point the device camera at the code, such that an image will be captured, as shown in the screen 908. The app decodes the QR code captured in the image in order to obtain an encoded product offer identifier.

Alternatively, if the user's device does not have a camera, or if the user only has a text code, selection of the touch screen button 906 may result in presentation of the display 910, enabling the user to enter a text code via an onscreen keyboard. The text code corresponds with the product offer identifier.

The smart phone device transmits the product offer identifier to the server system, which returns details of the offer, along with details of the one or more merchants associated with the product offer, and their corresponding prices. As shown in FIG. 9, an upper pane of the smart phone display 912 shows a description of the product, while touchable buttons 914, 916, 918 show associated merchants and their offer prices. In some embodiments, an associated image, such as a photograph of the product, may also be received from the server system, and may be displayed on the same, or on a separate, display screen.

The user is able to select a merchant by tapping on the corresponding touch screen button, e.g. 914, which results in the product order being added to a shopping cart 920 for subsequent purchase. At this stage, the user has the option of completing the order, by touching button 922, or adding further items to the shopping cart 920 by touching button 924. Touching button 924 results in the user being returned to the display showing the code entry buttons 904, 906.

If the user touches the complete order button 922, then a request to complete the purchase is transmitted back to the server system, which requests a transfer of funds from the relevant customer account to the selected merchant account via the payment gateway 716, and notifies the merchant 112 of the purchase. The customer is also notified of the success of the transaction, via the notification screen 926. Touching the ‘send receipt’ button 928 enables the user to request that a full receipt be sent, which may be delivered, for example, via email.

Additional supplier and merchant functions provided by the admin server 704, will now be described, with reference to a series of exemplary screen shots in FIGS. 10 to 13. Access to the administration server 704 may be provided via a web browser, i.e. the server 704 may implement a web server for receiving input from suppliers and merchants, and displaying corresponding output, as shown in FIGS. 10 to 13.

FIG. 10 shows a ‘campaigns’ page, which comprises a list 1002 of past and present campaigns. A campaign corresponds with a plurality of product offers, and may be, for example, an advertising campaign, a catalogue, or a coupon or voucher book.

In the screen 1000 each campaign is identified by a title 1004, and has a corresponding period 1006 for which it runs, between a nominated start date and corresponding end date. The column 1008 indicates the number of offers included in each campaign. A further column 1010 summarises the total number of offered products that have been purchased in each campaign. The column 1012 summarises the total revenue associated with the total number of purchased products. Column 1014 includes an indication of the current status of the campaign, e.g. ‘closed’ for completed campaigns, or ‘active’ for currently ongoing campaigns. Relevant actions are available as clickable links 1016, associated with each campaign. As will be appreciated, the summary data included in columns 1010, 1012 may be retrieved from the database 702, where it is maintained by the relevant processing modules as transactions occur.

A search facility 1018 is also provided, to assist in identifying campaigns of interest within the list 1002, particularly when the number of active and closed campaigns is relatively large. If a supplier or other user of the administration system wishes to create a new campaign, they can click on the ‘create new campaign’ button 1020.

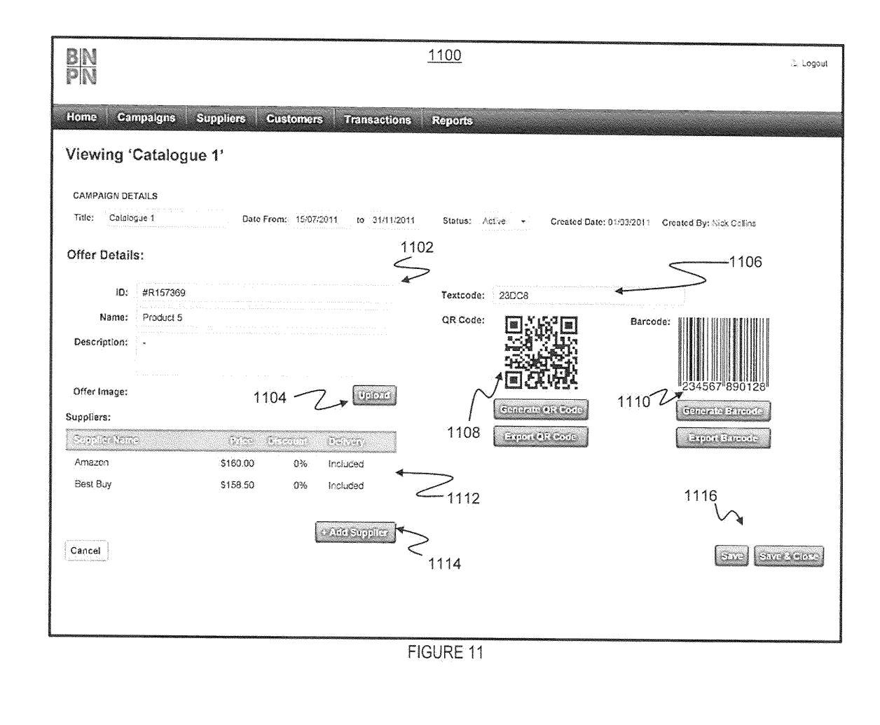

Turning now to FIG. 11, the exemplary display 1100 illustrates an interface for creation of a new product offer. Fields 1102 are provided for entry of the supplier or manufacturer's offer identifier, a product name, and a product description. An offer image may also be uploaded, by clicking on the ‘upload’ button 1104.

One or more encoded versions of a unique product identifier may also be entered or generated, including an alphanumeric text code 1106, a QR code 1108, and/or a bar code 1110. These codes are published in promotional materials advertising the product offer, for entry by a customer, for example as described above with reference to FIG. 9.

Merchants participating in the product offer are identified in a list 1112 which includes the merchant name, the price at which the merchant will sell the product as part of the offer, along with other relevant details. Additional merchants may be added by clicking on the ‘add supplier’ button 1114. Clicking on the one of the ‘save’ buttons 1116 will result in the offer details, and associated merchant and price details, along with the product offer codes, being stored to the relevant product offer records within the database 702.

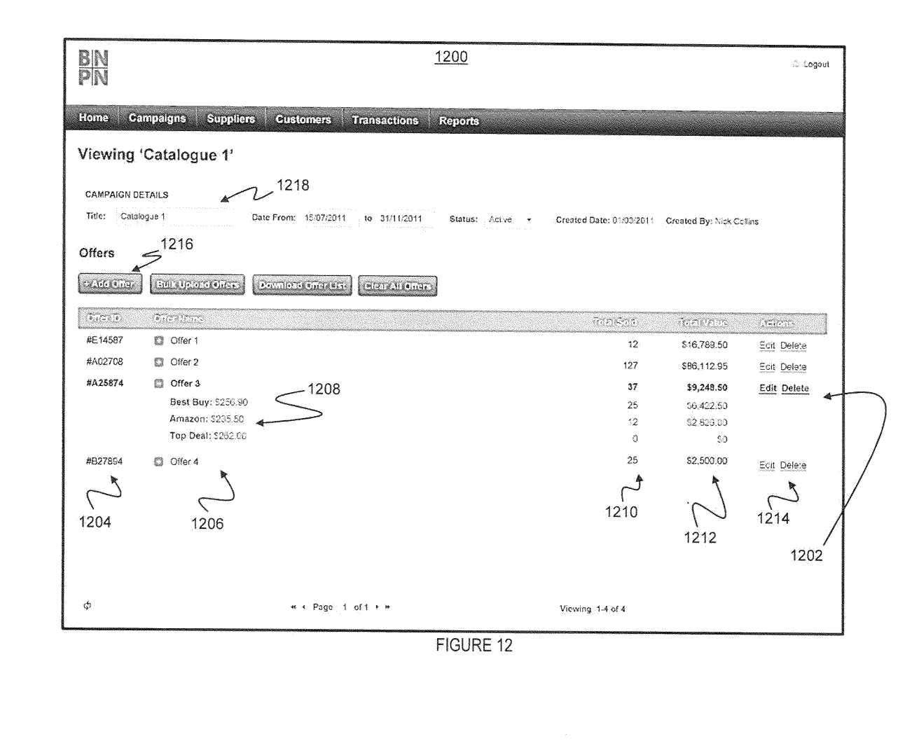

FIG. 12 shows a display screen 1200 comprising details of the product offers within a campaign. A list 1202 identifies each offer, including the manufacturer or suppliers identifier 1204, and the name of each offer 1206. The offer list can be expanded 1208 in order to show the corresponding merchants signed up in association with the offer, and their offer prices. The column 1210 shows the total number of each product sold for each offer, and for the individual merchants. The total value of sales is shown in column 1212. Additional actions are provided by clickable links 1214, such as for editing or deleting a product offer.

In order to add a new offer to the campaign, the use clicks on the ‘add offer’ button 1216.

When a new campaign is created, by clicking on the ‘create new campaign’ button 1020, the list 1202 is initially empty, and the use is able to enter the campaign details for the new campaign within the provided fields, e.g. 1218.

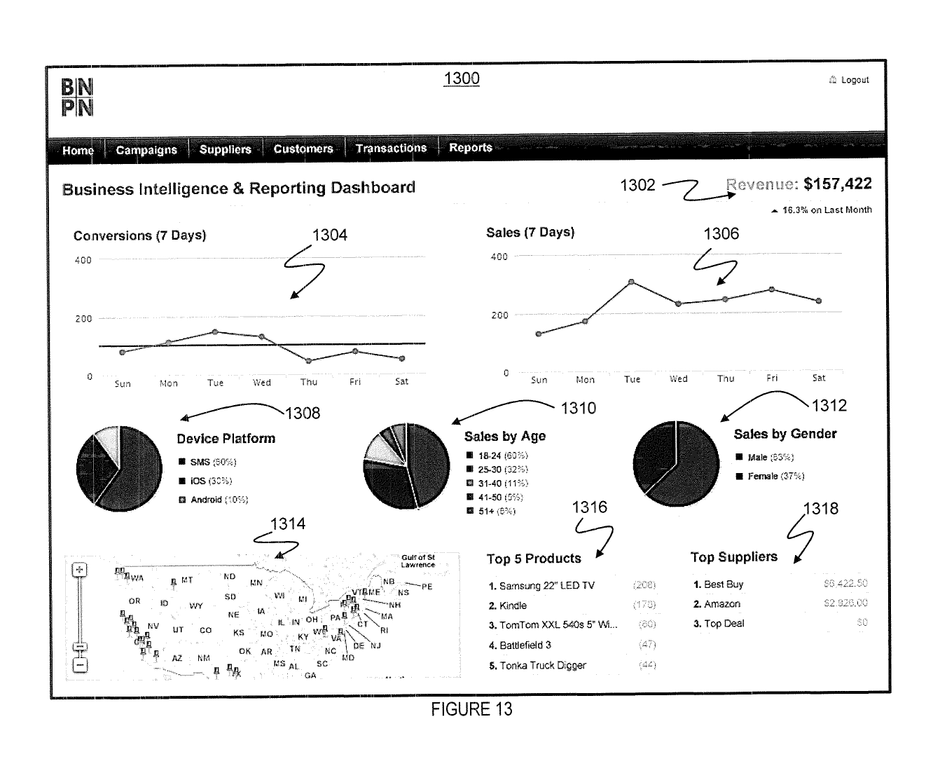

FIG. 13 shows a display screen 1300 comprising a business intelligence and reporting dashboard. This screen exemplifies additional information that may be available to merchants and suppliers (i.e. campaign operators), based upon transaction records and customer details stored within the database 702. For example, the dashboard 1300 shows total revenue for the campaign 1302. A graph 1304 shows conversions (i.e. the proportion of product views resulting in sales) over the past seven days, and graph 1306 shows the absolute number of sales over the same period.

Additional analytics available within the dashboard 1300 include a breakdown of the OS platform used by customer devices 1308, a breakdown of sales by age 1310, and a breakdown of sales by gender 1312. All of this information may be extremely useful to a campaign operator when designing future campaigns. For example, the device platform analytics 1308 indicate that a majority of customers are utilising SMS messaging, rather that iOS- or Android-based smart phones, which indicate the significant importance of providing a text code. Breakdowns of sales by age and gender 310, 312 may be of assistance in determining which products are of interest to which segments of the market.

A map display 1314 includes pins showing the locations of customers who have purchased items during the campaign. Additionally, the dashboard 1300 includes listings of the top five products 1316 in the campaign, and the top suppliers 1318.

In some embodiments, the dashboard 1300 enables the user to drill down further into the results, for example to provide further details of relative popularity of products, breakdowns by age and gender, breakdowns by age and location, and/or other combinations of customer characteristics. The particular analytics shown in the reporting dashboard 1300 are therefore not intended to be exhaustive, and are shown by way of example only.

In summary, embodiments of the present invention enable powerful and flexible promotional campaigns to be developed, in which promotional codes can be provided via both online and offline (e.g. print) media, and registered customers may easily access an online e-commerce system for completing a product purchase based upon entry of a unique product offer code. The e-commerce system may be implemented as a highly scalable architecture, and deployed, for example, on a cloud computing platform, so that it is able to handle periods of very high demand. For example, if coupon books are distributed on a weekly basis, it is known that demand reaches a peak on the first day of the campaign, and then tails off during the remainder of the week. The e-commerce system therefore needs to be capable of handling the high demand at the beginning of the campaign, while freeing up resources to reduce operating costs during periods of lower demand.

While particular embodiments and variations of the invention have been described herein, further modifications and alternatives will be apparent to persons skilled in the relevant art. Accordingly, the described embodiments are not limiting of the scope of the invention, which is as defined in the claims appended hereto.

1. A method of operating a server computer system to facilitate transactions between a plurality of merchants and a plurality of customers, wherein each customer is associated with at least one customer device in communication with the server computer system via a communications network, the method comprising the steps of:
providing at least one database configured to contain customer records, merchant records and product offer records, wherein
each customer record includes a unique customer identifier, and information identifying a customer payment account,
each merchant record includes information identifying a merchant deposit account, and
each product offer record includes a unique product offer identifier and a product description, and wherein
each product offer record is associated in the database with one or more corresponding merchant offers, each of which comprises a product price associated with a corresponding merchant record;
the server receiving from a customer device a customer identifier and a product offer identifier;
the server retrieving from the database a product offer record corresponding with the product offer identifier, and transmitting the product description stored in the product offer record to the customer device;
the server retrieving from the database one or more merchant offers associated with the retrieved product offer record and transmitting corresponding merchant details and the product price in each merchant offer to the customer device;
the server receiving from the customer device a selection of one of the retrieved merchant offers;
the server executing a transaction, including transferring funds to the merchant deposit account from the customer payment account corresponding with the customer identifier; and
the server transmitting a notification message to the merchant system, including details of the executed transaction.

2. The method of claim 1 wherein the unique customer identifier comprises one or more of a telephone number, an email address, or a user name.

3. The method of claim 1 including a step of the server transmitting messages comprising one or more product offer identifiers to at least one customer device, whereby the product offer identifier received from the customer device is selected by the customer from the messages.

4. The method of claim 1 wherein the product offer identifier received from the customer device has been distributed in an online or offline promotional campaign, and has been input by a customer to the customer device for transmission.

5. The method of claim 4 wherein the product offer identifier has been distributed in the form of one or more of a text code, a bar code, or a QR code.

6. The method of claim 1 wherein each customer record further comprises one or more of the following items of customer information: customer delivery details; customer billing address; customer personal details, including one or more of age, gender, educational background or professional background; customer interests; or records of past customer purchases.

7. The method of claim 1 wherein the database also contains records of customer requests for product offer information, records of customer selections of merchant offers, and records of transactions, and further including providing an administrative interface enabling authorised parties to access detailed records relating to purchases or promotional campaigns.

8. The method of claim 7 wherein the administrative interface comprises a web server configured to serve pages including graphical and/or numerical campaign analytics.

9. A server computer system comprising:
at least one processor;
persistent storage accessible to the processor comprising at least one database configured to contain customer records, merchant records and product offer records, wherein
each customer record includes a unique customer identifier, and information identifying a customer payment account,
each merchant record includes information identifying a merchant deposit account, and
each product offer record includes a unique product offer identifier and a product description, and wherein
each product offer record is associated in the database with one or more corresponding merchant offers, each of which comprises a product price associated with a corresponding merchant record;
at least one network interface operatively associated with the processor and configured to communicate with a plurality of customer devices; and
a memory operatively associated with the processor,
wherein the memory comprises data and executable program instructions configured to cause the processor to execute a method comprising steps of:
receiving from a customer device a customer identifier and a product offer identifier;
retrieving from the database a product offer record corresponding with the product offer identifier, and transmitting the product description stored in the product offer record to the customer device;
retrieving from the database one or more merchant offers associated with the retrieved product offer records, and transmitting corresponding merchant details and the product price in each merchant offer to the customer device;
receiving from the customer device a selection of one of the retrieved merchant offers;
executing a transaction, including transferring funds to the merchant deposit account from the customer payment account identified in the customer record associated with the customer identifier; and
transmitting a notification message, to the merchant system, including details of the executed transaction.

10. A method of operating a customer device in communication with a server computer system which is configured to facilitate transactions between a plurality of merchants and a plurality of customers, wherein the server computer system is associated with at least one database configured to contain customer records, merchant records and product offer records, wherein
each customer record includes a unique customer identifier, and information identifying a customer payment account,
each merchant record includes information identifying a Merchant deposit account, and
each product offer record includes a unique product offer identifier and a product description, and wherein
each product offer record is associated in the database with one or more corresponding merchant offers, each of which comprises a product price associated with a corresponding merchant record;
wherein the customer device operation method comprises:
the customer device receiving an input including a product offer identifier;
the customer device transmitting to the server computer system a customer identifier associated with a user of the customer device, and the product offer identifier;
the customer device receiving from the server computer system a product description, and displaying the product description on a device display;
the customer device receiving from the server computer system details of one or more merchants associated with the product offer, and corresponding product prices, and displaying merchant details and prices on the device display;
the customer device receiving a selection of one of the displayed merchant offers, and transmitting the selection to the server computer system,
whereby the server computer system is able to execute a transaction, including transferring funds to the merchant deposit account from the customer payment account associated with the customer identifier and to transmit a notification message to a corresponding merchant system including details of the executed transaction.

11. A computer program product comprising a tangible computer-readable medium having stored thereon computer-executable instructions which, when executed on a customer device, cause the customer device to implement a method according to claim 10.

12. The computer program product of claim 11 wherein the tangible computer-readable medium is operatively associated with a network-connected server, and the computer-executable instructions comprise one or more files available for download via the network, and configured to install the computer-executable instructions on the customer device.
